(19) United States
(12) Patent Application Publication
(10) Pub. No.: US 2010/0135472 A1
(43) Pub. Date: Jun. 3, 2010

(54) AUTOMATED VOICE MAIL COMMUNICATION SYSTEM

(76) Inventors: Timothy Watanabe, San Jose, CA (US); Kenneth Poray, Point Pleasant Beach, NJ (US); Craig So, San Jose, CA (US); Ryan Menda, San Jose, CA (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 12/620,075

(22) Filed: Nov. 17, 2009

Related U.S. Application Data
(60) Provisional application No. 61/115,583, filed on Nov. 18, 2008.

(51) Int. Cl. H04M 1/64; G10L 13/00; G10L 15/26

(52) U.S. Cl. 379/88.08; 704/260; 704/235; 704/E13.001; 704/E15.043

(57) ABSTRACT

Methods and systems for automating communication and interaction with voice mail systems are described. The systems comprise a platform capable of handling multiple types of communications with multiple users and systems. The platform contains a browser, one or more servers for handling communications between the platform and user devices that are external to the platform, a speech engine for converting text to speech and vice versa, a chat server, an email server, a text server, a data warehouse, a scheduler, a workflow/rules engine, a reports server, and integration APIs that can be integrated with 3^{rd} party systems and allow those systems to be integrated with the platform. The platform is linked to multiple users (and their devices or systems) through a communications network. The platform can be used to navigate telephone prompts, deliver a complete message on a voice mail system and verify that the complete message has been left, use voice recognition or touchtone recognition to collect information from a user or the voice mail, record any of these transactions, and allows a user to create and customize these features, as well as obtain a customized reporting through a user interface with the platform. Other embodiments are described.

### CROSS-REFERENCE TO RELATED APPLICATION

This application claims priority of U.S. Provisional Application Ser. No. 61/115,583, filed on Nov. 18, 2008, the entire disclosure of which is incorporated herein by reference.

### FIELD

This application relates generally to methods and systems for communication. In particular, this application relates to methods and systems for automating communication and interaction with users and their voice mail systems.

### BACKGROUND

Information has traditionally been communicated via methods such as radio, television (TV), telephones, and newspapers. Recently, information has been communicated by more digital mechanisms such as the internet (including web interfaces), email, instant messaging, and social networking services/interfaces (like Facebook, MySpace, Twitter, Yahoo, AIM), and text messaging.

Some of these communication methods have been initiated for the purpose of collecting a payment, to an account holder (i.e., a doctor's office) from the account owner (i.e., a patient) or for the purpose of reminding the patient of an upcoming appointment with the doctor's office. These payment communication methods have typically been performed by mail, phone calls, and in certain instances via email. The communication by phone interaction has usually been limited to 1-to-1 phone calls that are manually initiated by a person and when not received by a live person, a message has been left on the recipient's voice mail system. During the last several years, interactive voice applications (IVR) have allowed callers to access information over the phone in an automated or semi-automated fashion.

### SUMMARY

This application relates to methods and systems for automating communication and interaction with voice mail systems. The systems comprise a platform capable of handling multiple types of communications with multiple users and systems. The platform contains a browser, one or more servers for handling communications between the platform and user devices that are external to the platform, a speech engine for converting text to speech and vice versa, a chat server, an email server, a social networking server, a text server, a data warehouse, a scheduler, a workflow/rules engine, a reports server, and integration APIs that can be integrated with 3^{rd} party systems and allow those systems to be integrated with the platform. The platform is linked to multiple users (and their devices or systems) through a communications network. The platform can be used to navigate telephone prompts, deliver a complete message on various voice/message systems and verify that the complete message has been left, use voice recognition or touchtone recognition to collect information from a user or the voice mail, record any of these transactions, and allows a user to create and customize these features, as well as obtain a customized reporting through a user interface with the platform.

### BRIEF DESCRIPTION OF THE DRAWINGS

The following description can be better understood in light of the Figures, in which:

FIG. 1 depicts some embodiments of the communication systems;

FIG. 2 illustrates an exemplary computer apparatus that can be used in some embodiments in the communication systems;

FIG. 3 illustrates an exemplary network that can be used in some embodiments in the communication systems;

FIG. 4 depicts some embodiments of the communication systems with minimal involvement by a user;

FIG. 5 depicts some embodiments of the communication systems with increased involvement by a user;

FIG. 6 depicts some embodiments of the communication systems with even more increased involvement by a user;

FIG. 7 depicts some embodiments of multiple users communicating with each other using the communication system; and

FIG. 8 show some methods for communication between the platform, a user, and the user's voice mail system.

The Figures illustrate specific aspects of the methods and systems for automating communication and interaction with voice mail systems. Together with the following description, the Figures demonstrate and explain the principles of the methods and apparatus used by these methods. In the drawings, the thickness of layers and regions are exaggerated for clarity. The same reference numerals in different drawings represent the same element, and thus their descriptions will not be repeated.

### DETAILED DESCRIPTION

The following description supplies specific details in order to provide a thorough understanding. Nevertheless, the skilled artisan would understand that the apparatus and associated methods of making and using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on using the communication system for payment transactions, it could be used in and applied to other types of transactions, like insurance, medical, or mortgage servicing transactions.

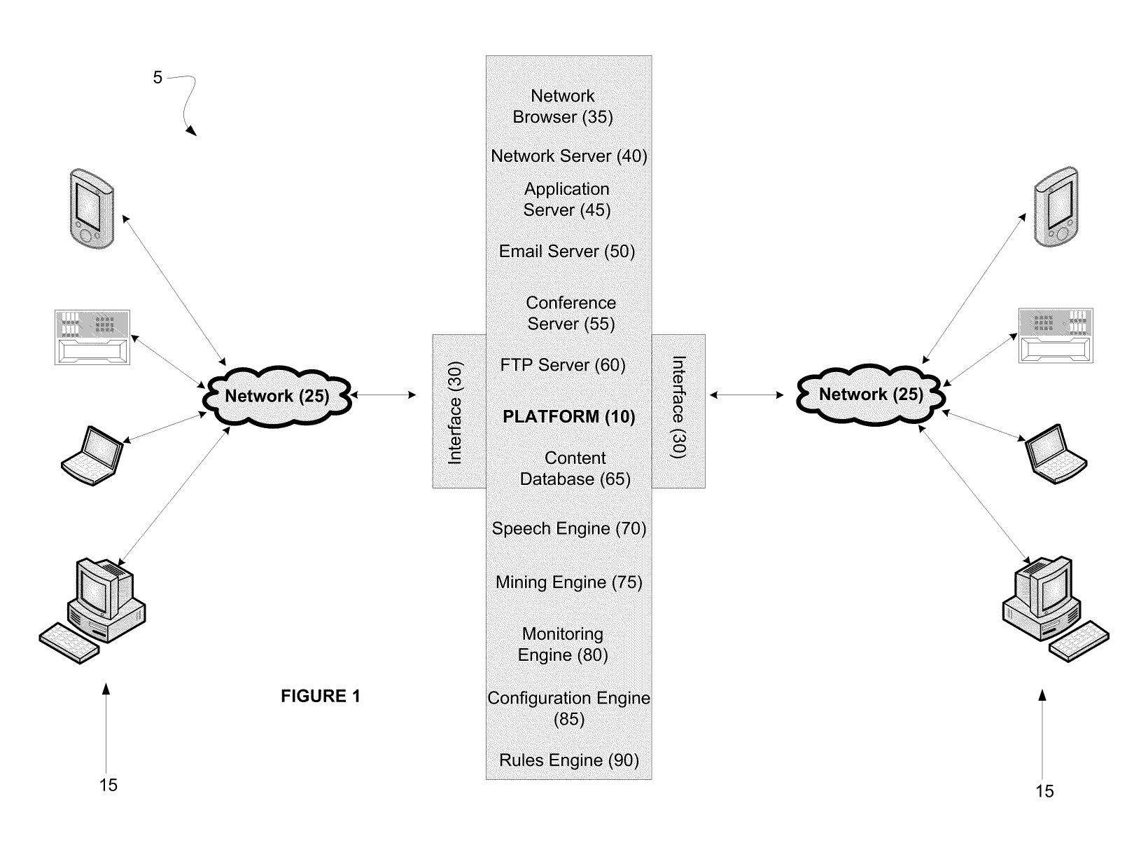

Some embodiments of the methods and systems for automating communication and interaction with voice/messaging systems are shown in FIGS. 1-8. The messaging systems include both voice messaging systems (including voice mail), email messaging systems, instant messaging systems, and the like. In these embodiments, the system comprises a platform that functions to send and/or receive encrypted or unencrypted data, text, audio, visual, or any other digital information to and/or from multiple users. Any (or all) of the users can use any desired combination of communication mechanisms including static, dynamic, manual, or automated communication mechanisms rather than being restricted to a single communication channel.

In the embodiments shown in FIG. 1, the system 5 comprises a platform 10 that is in communication with various users using any combination of user devices 15 through a communications network 25. Prior to discussing the details of system 5, it should be understood that the following description is presented largely in terms of processes and operations that may be performed by any known computing components. These computing components, which may be grouped in a single location or distributed over a wide area, generally include computer processors, memory storage devices, display devices, input devices, etc. In circumstances where the computer components are distributed, the computer components are accessible to each other via communication links, such as those illustrated in FIG. 1. The system 5 could equally operate within a computer system having a fewer or greater number of components than those illustrated in the Figures. Thus, the depiction of system 5 should be taken as illustrative and not limiting. For example, the system 5 could implement various services components and peer-to-peer network configurations to implement at least a portion of the processes. The solution can be used in an “on premise” solution, as well as in a software-as-a-service configuration.

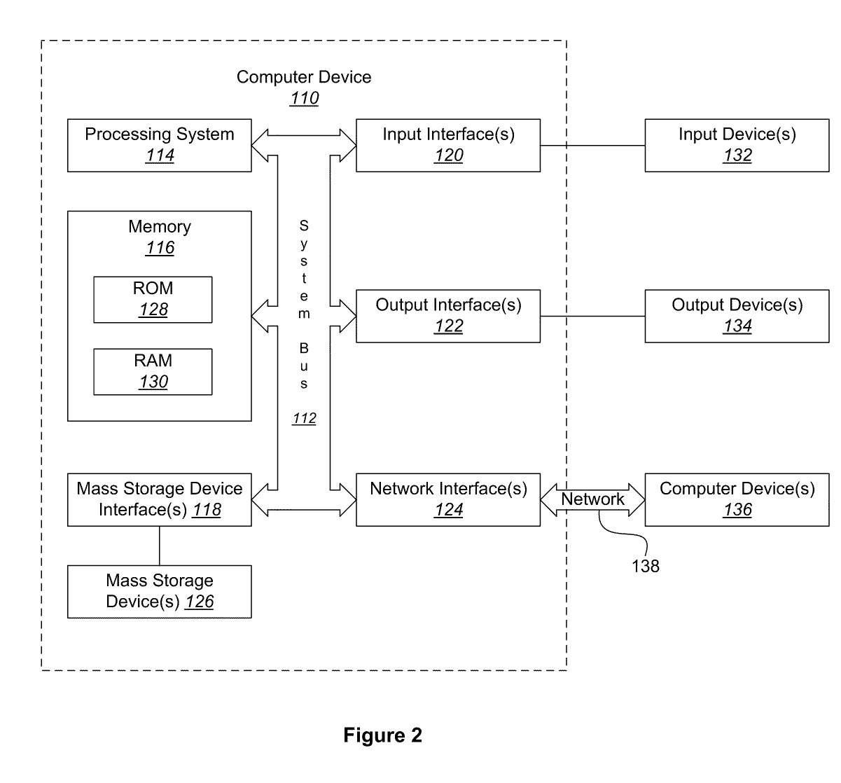

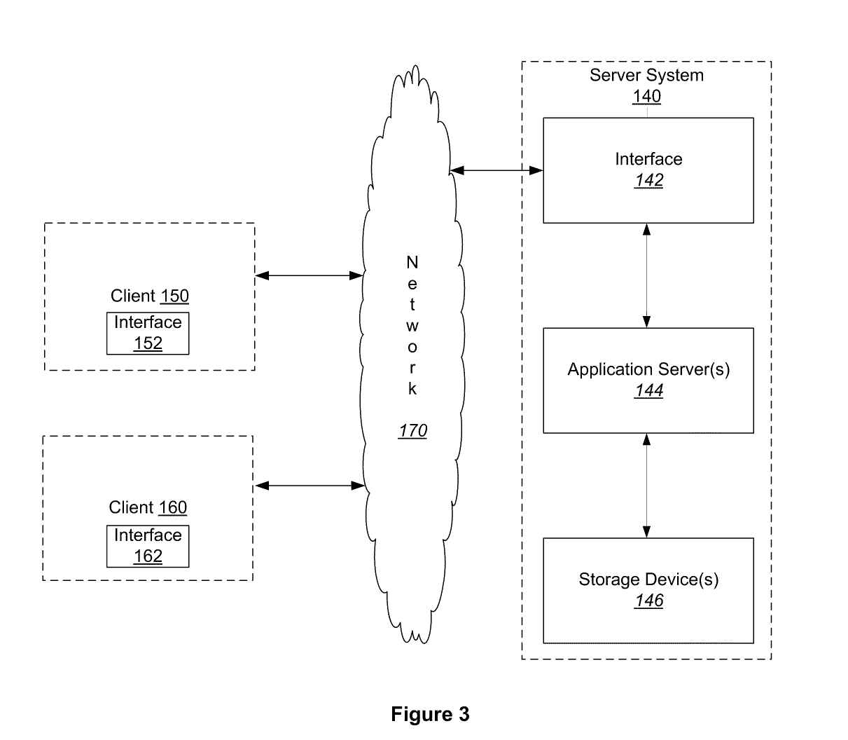

In some embodiments, FIGS. 2-3 illustrate one computing environment in which the system may be implemented. These embodiments contain one or more computer readable media that may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 2, the system includes computer device 110, which may be a general-purpose or special-purpose computer. For example, computer device 110 may be a personal computer, a notebook computer, a tablet computer, a personal digital assistant (“PDA”), smart phone, or other hand-held device, a workstation, a minicomputer, a mainframe, a supercomputer, a multi-processor system, a network computer, a processor-based consumer electronic device, or the like.

The computer device 110 includes system bus 112, which may be configured to connect various components thereof and enables data to be exchanged between two or more components. The system bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124.

The processing system 114 includes one or more processors, such as a central processor and optionally one or more other processors designed to perform a particular function or task. It is typically processing system 114 that executes the instructions provided on computer readable media, such as on memory 116, a magnetic hard disk, a removable magnetic disk, a magnetic cassette, an optical disk, or from a communication connection, which may also be viewed as a computer readable medium.

The memory 116 includes one or more computer readable media that may be configured to include or includes thereon data or instructions for manipulating data, and may be accessed by processing system 114 through system bus 112. The memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, tape drives and optical disk drives. A mass storage device 126 may read from and/or write to a magnetic hard disk, a removable magnetic disk, a magnetic cassette, an optical disk, or another computer readable medium. Mass storage devices 126 and their corresponding computer readable media provide nonvolatile storage of data and/or executable instructions that may include one or more program modules such as an operating system, one or more application programs, other program modules, or program data.

One or more input interfaces 120 may be employed to enable a user to enter data and/or instructions to computer device 110 through one or more corresponding input devices 132. Examples of such input devices include a microphone, a joystick, a game pad, a satellite dish, a scanner, a camcorder, a digital camera, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 120 that may be used to connect the input devices 132 to the system bus 112 include a serial port, a parallel port, a game port, a universal serial bus (“USB”), a firewire (IEEE 1394), or another interface such as data that can be entered via a phone using a voice.

One or more output interfaces 122 may be employed to connect one or more corresponding output devices 134 to system bus 112. Examples of output devices include a speaker, a printer, a visually perceptible output device (e.g., a monitor, display screen, or any other suitable visualization device), and the like. A particular output device 134 may be integrated with or peripheral to computer device 110. Examples of output interfaces include a video adapter, an audio adapter, a parallel port, and the like.

One or more network interfaces 124 enable computer device 110 to exchange information with one or more other local or remote computer devices, illustrated as computer devices 136, via a network 138 that may include hardwired and/or wireless links. Examples of network interfaces include a network adapter for connection to a local area network (“LAN”) or a modem, wireless link, or other adapter for connection to a wide area network (“WAN”), such as the Internet, or phone/cellular network for instance 3G. The network interface 124 may be incorporated with or peripheral to computer device 110. In a networked system, accessible program modules or portions thereof may be stored in a remote memory storage device. Furthermore, in a networked system computer device 110 may participate in a distributed computing environment, where functions or tasks are performed by a plurality of networked computer devices.

The system may be operated in networked computing environments with many types of computer system configurations. FIG. 3 represents some embodiments of a networked environment that includes clients 150 and 160 connected to a server system 140 via a network 170. While FIG. 3 illustrates an embodiment that includes two clients connected to the network, alternative embodiments include one client connected to a network or many clients connected to a network. Moreover, some embodiments also include a multitude of clients throughout the world connected to an electronic network, where the network can be a wide area network, such as the Internet.

Returning to FIG. 1, the user devices 15 comprise any communication device known in the art. In some embodiments, the user devices 15 comprises any computing device like a desktop computer, a laptop computer, a server, a telephone, a mobile or cellular phone, a smart phone, a personal digital assistant (such as a Palm Pilot, iPaq, Blackberry device), an automated calling system, any known interactive voice response (IVR) device, an answering machine, a portable electronic device, a mobile hand held device, any electronic device containing computing software or an application programming interface (API), 3^{rd} party software (like Lytec, Allscripts, etc), other service providers such as multi-payer solutions like NaviNet, or any combinations thereof. The user's device 15 can communicate using any technology, operating system, or software configuration known in the art.

The communication by the user's device 15 can be made using any technologies known in the art. These technologies include wireless transfers (i.e., Blootooth, Wi-Fi, Wi-Max, cellular phone, etc.), network transfers via any protocol, and bus transfers between devices attached to the same computer processing unit via connectivity such as USB port, FireWire IEEE-1394, serial port, parallel port, PCMCIA, CompactFlash, SecureDigital, or like ports or means of electronic connectivity.

In other embodiments, the user devices 15 comprise multiple devices or components sufficient to create a system. In these embodiments, the multiple devices/components are combined into creating a computing environment in which the user operates. Examples of user systems include a LAN, WAN, cellular networks, phone lines, internet, intranet, or the like. One particular example of a user system comprises the internal computing network of an insurance company, a hospital, or a doctors' office.

The system 5 is not limited to just communicating with users. In some embodiments, the system 5 can communicate with non-users through their devices and/or systems. Non-user systems and/or devices can contain software including, for example, Lytec, AllScripts, etc. Examples of non-users systems/devices include system software like Lytec and AllScripts, insurance company data services (sometimes web services or EDI), or IVRs.

The network 25 comprises any electronic communication network known in the art that, in certain configurations, is capable of using the communication employed by the user (or non-user) device(s) (or systems). In some embodiments, the communication network 25 comprises a wide area network, a local area network, a telephone/cellular network, internet services like email, instant messaging, SMS, or combinations thereof.

The types of communication channels in the network 25 can include any of those known in the art. These communication channels include any phone communication (including interactive phone communication through speech or touchtone recognition, IVR, or text-to-speech playback), email, text messaging, SMS, instant messaging (IM), internet communication (such as through a web interface), voice mail, video communication (i.e., video conferencing or Skype conference), system APIs, database calls, or any communication that connects/transfers people or systems to communicate to each other using any type of electronic device or communication mechanism.

The platform 10 can coordinate the sending and/or receiving of data (including any needed digital content) between multiple users using multiple communication channels at the same time. In some configurations, the platform can trigger outbound communications, including interactive calls, chat messages, emails, SMS messages, API integration, etc. These can be coordinated with inbound communications, including interactive calls, chat messages, emails, SMS messages, API integration, etc. that are received by the platform 10. In some embodiments, the outbound communications can automatically retrieve information from any of the users (including individuals via a phone, IVRs, systems, etc.) and make that info available via reports which can include recordings. For instance, the platform could call into an insurance company and get a claims status via an agent or via IVR, can record what was said, and the provider agent could listen to the recording or view the report using the platform whenever desired.

The communication functionality of the platform 10 can include generation of alerts, notifications, reports, user-configurable static or dynamic applications, speech recognition, touchtone recognition, speech-to-text generation, text-to-speech playback, xml, web pages/applications, or any combination thereof that may or may not be integrated together. For example, if a user needs to answer 10 questions and the user answers 7 of them on the phone, when the user logs onto the web, the user can simply answer the remaining 3 without having to start the answering process over from the beginning. The platform 10 comprises any component or combination of components described above that provides any—or all—of these functions. In some configurations, the platform may use a single or multiple functions at a time and those functions can—if desired—interact with each other. In other configurations, all of the functions are capable of working at the same time and interacting with each other. So, for example, if the platform 10 was used to create an application that interacts with a user on a specific topic (i.e., it asks a user “Did you feed the dog?”), that application can be simultaneously used in any or all of the following applications: outbound phone/voip, inbound phone/voip, outbound email/web, inbound email/web, outbound SMS, etc. Thus, if a user receives a voice mail on this topic from the platform, the user can respond to the voice mail via the web or IM or email or whatever communication channel that works best for them.

One of the components that can be contained in the platform 10 includes a network browser 35. This browser can be used to view, organize, analyze, and utilize the information and data in the platform 10. In some configurations, the browser 35 can control the software which a system operator can use to control the operation of the platform 10. In some embodiments, the network browser 35 can comprise an HTML browser, an XML browser, a VXML browser, or combinations thereof.

Another component that can be contained in the platform 10 includes a server. Any type of server known in the art can be used. Examples of servers that can be used include a computer running a UNIX-style operating system, a computer running a Microsoft Windows operating system, Macintosh, or a personal computer workstation. The server can comprise any storage component on which digital information or content can be stored. Examples of storage components include optical storage discs, DVD-RAM discs, and traditional magnetic hard disc drives. In some configurations, the storage component could be a server in a network operations center (NOC).

Another example of a storage component includes any known database (or combination of databases). The database stores any desired information, including information regarding the digital content and any user interaction with the platform. For example, the database stores data regarding any specific user device(s). The database can also store sales information, user information, transactional information, reporting information, data warehousing, etc. As an example of the data warehousing, the platform can store any or all of the desired interactions (for instance, call recordings) as well as the static application used to contact/interact with the user during a transaction. The database may include a Microsoft SQL database, a Microsoft Access database, an Oracle database, a MySQL database or combinations thereof.

In some aspects, multiple servers may be connected together to make a server cluster. Using a server cluster permits sharing information about the data stored on each server and each transaction or event the server has recorded. By using a server cluster, the system 5 is always operational, regardless of the location of a particular component on the network that connects the components (such as the internet). The server cluster can contain a primary cluster, which handles all critical tasks, with minor functions being routed to a secondary cluster. With this configuration, if the primary cluster is not operational, most functions can be handled by the secondary cluster. A server cluster also allows for large-scale deployment and interoperability, as well as data that can be stored on the network in multiple points of co-location. In some configurations, there will be server redundancy as well as site redundancy for the servers.

The software components required for operating the server may be included on a single server or on multiple servers, with each server implementing one or more tasks and communicating among themselves using standard networking protocols. Non-limiting examples of the server-focused tasks using the software components that may be implemented on one or more servers including an e-mail server; network server; application server; conference server; ftp server; file server; user device server; speech/voice server, content management server; content synchronization server; chat server, reports server, SMS server; content security server; and advertising/promotional message server.

In some embodiments, such as those depicted in FIG. 1, the platform 10 can contain a network server 40. The network server 40 organizes and manages the data and information coming in from, and out to, the network 25. Thus, the network server can serve to manage all of the communications in the platform 10.

In the embodiments depicted in FIG. 1, the platform 10 can also contain one or more application servers 45. The application server 45 manages the operation of the various software applications and/or paths/workflow that reside on the platform 10.

In the embodiments depicted in FIG. 1, the platform 10 can also contain one or more email servers 50. The email server 50 manages and organizes all of the email related information and data coming into and out of the platform 10 through any email communication method.

In the embodiments depicted in FIG. 1, the platform 10 can also contain a conference server 55. The conference server 55 manages the operation of any conference between an operator of the platform and any user (or combination of users) or any group of users.

In the embodiments depicted in FIG. 1, the platform 10 can also contain an FTP server 60. The ftp server 60 manages and organizes all of the information and data coming into and out of the platform 10 through a file transfer protocol (FTP) communication method.

In some configurations, the platform 10 can also contain a content database 65 that manages and stores digital content or data. The types of digital content that can be stored (and then delivered to a user) are virtually unlimited. Examples of the digital content include music, software, mobile phone ring tones, electronic books, advertising, and other types of content. The format in which the digital content is stored is also virtually unlimited. Examples of the types of digital formats include pdf, doc, xls, jpeg, tiff, gif, xbm, pnm, mpeg2, mpeg4, mp3, mp4, oma, m4a, wma, wmv, mov, way, avi, xml, html, php, pl, jar, exe, alaw, vox, au, pcm8, pcm16, csv, txt, xls, and vxml, as well as combinations thereof. The digital content can also be provided in any known computer or human language. The digital content may be provided internally (by the entity that controls or operates the platform 10), or externally by one or more third parties that may be the copyright owners of the content or that act on behalf of the owners of the content, or even a user (collectively, content providers).

The servers can insert the content or data into any desired communication. For example, the database could insert a text file into a phone call or could insert an audio file into an email, SMS, chat, API, or text message. In some embodiments, the content is inserted into the desired communication based on one or more characteristics that match the communication. For example, text from an excel spreadsheet or other system database/API can be inserted into an outbound call, thereby customizing the information spoken to the user. For example, an outbound call can contain the statement “Hello, this is Dr. Smith's office. [John Doe] has an appointment on [Monday, January 15^{th}] at [3:30 pm].” In this case, the various values within the brackets [ ] are taken from an excel spreadsheet and then inserted into the phone/voice application. In some configurations, the content database can contain a rules engine 90 which matches the content with the communication based on these characteristics. For example, if a specific user prefers email when interacting with the platform, when it's time to contact that user, the rules engine will determine that it could send them an email instead of calling them. Thus, the platform contains a way for users to input their personal information as well as preferred communication mechanisms. This personalization can be configured by time, event, or over-ride values.

In some embodiments, the platform 10 also contains a voice platform and/or speech engine 70, as shown in FIG. 1. The speech engine 70 operates both as a speech recognition engine which can automatically convert speech into text, as well as an automated speech generation engine which can automatically convert text into speech. Thus, the speech engine 70 can accepts voice and dtmf (button presses) as input and navigate the voice options accordingly.

The platform 10 can also contain a mining (or reporting) engine 75 as shown in FIG. 1. The mining engine operates to analyze the data present in—or flowing through—the platform 10 from all of the various communications. The analyzed data can then be used for many purposes, including optimizing the operation of the platform 10, customer specific reports, setting rules for the data/information that would trigger an alert or a notification, recipient engagement/progress results, or a combination thereof.

The platform 10 can also contain a monitoring engine 80. The monitoring engine 80 operates to monitor the operation of the various components of the platform 10. The monitoring engine therefore contains API' s for data integration and data services (including web services, RSS, email, XML, API, FTP), with integrated triggering services for initiating any outbound communication via phone, job manager, reporting/statistics/logging service, billing and accounting service, multi-tenancy manager, user account (profile) manager which allows for user profiles to be established defining the various ways an individual may be contacted based on preferred device and based on time of day or day of week, resource and configuration manager, and scheduling service manager.

In some embodiments, the monitoring engine 80 allows any information or data associated with any user, and/or that user's activities (“user data”) to be securely and appropriately observed by and/or communicated to other parts of the platform, others users, and/or the third parties. User data, among other things, may comprise of information about the user. For instance, user ID, password, and phone number for purposes of connecting various users together. It can also store the user's respective role for things like feature or report accessibility. It can also store preferred contact protocols. For example, for general public users, you can set up a preference such as, if a call is coming in from the CallerID associated with a specific person (MOM), send it to my cell phone. Otherwise, send it to voice mail. Another example is if a call comes in prior to 5 pm, send it to my work phone or have it record a message and send that message to my email. Another example is, if an email is from my boss, call me immediately and read it in text to speech. This can allow users a control protocol to handle their communications. As a further example, a user can have a cell phone that no one knows their number. They can also have a second number that they tell people and have forwarded to their original number. If they are getting too many calls and want to change their publicly known number, they can without changing their real cell phone number. Also, information associated to the operation of any given user device and information related to the entered and/or non-entered activities of users can be monitored. Entered user activities may include, for instance, information the user inputs into the system, i.e., keystrokes, cursor movements, and the like. Additionally, non-entered user activities may include activities such as the user's body movements and expressions that the user does not input, but that can be captured or observed by the user's device.

A monitoring engine 80 may function in any manner that allows either an operator of the system or a third party to perform the desired monitoring. For example, a monitoring engine may gather and relay user data by running continuous built-in tests (“CBIT”) and transparently monitoring without disabling a user device or ending software applications. In another example, the monitoring engine may gather information or allow a third party to monitor a user device by taking screen shots, interrogating the system and sub-systems, and receiving information from sensors, the CPU, input and output devices, and/or the like. In yet another example, the monitoring engine can be used to monitor the health of the system, including for CPU utilization, low remaining disk space, low memory, etc. As described herein, this monitoring action can be integrated with other parts of the system to allow administrators real time access to their systems. For example, if a user's computer/server is running low on memory, an alert can be sent to the platform which can then notify an administrator and ask questions like, “Would you like to run a diagnostic test?” If the answer is “yes”, the platform can run the test and give the results to the administrator. Upon delivering the results, the platform can ask the administrator what actions could be taken on behalf of the user, i.e., the platform could ask “Would you like me to reboot, fail-over to the backup servers, or do nothing for now?” If the administrator responded with a certain option, the platform could then take the desired action.

The platform 10 can also contain a configuration engine 85 as shown in FIG. 1. The configuration engine allows the operator of the platform to design and develop software application templates, containing an application and a template. The configuration engine contains audit capabilities for storing “static” applications and recipient interactions. For example, with outbound phone call, the configuration engine can use a network of local (relative to the user) phone numbers and/or caller IDs in the communication method. As another example, the configuration engine has the ability for on-hold management which allows a user to be placed on hold until either an agent or the speech engine picks up, or a predefined limit (say 10 minutes) is incurred. Also, it can configure hours of operation for a particular user's agents.

The platform 10 can be connected to the network 25 through an interface 30 that allows the platform to interact with the various user devices and the different communication methods they use. The interface 30 accordingly comprises any known phone interface like Session Initiation Protocol (SIP), Simple Object Access Protocol (SOAP), Skype, and VOIP. The interface also contains an email interface (like Microsoft Exchange or SendMail), an IM interface (like Skype, Yahoo Instant Messenger, Twitter, Jabber), and web interfaces like a “screen pop.”

With such components, the platform 10 can be used to receive data (including content) and information from the user device (or system) 15 via sources such as the network server, conference server, ftp server, and/or the email server. As well, the platform 10 can send data and information to the user devices 15 via mechanisms such as the web server, ftp server, network server, the email server, and/or phone. As well, the platform can send or receive data by mechanisms like API Integration and voice mechanisms like phones, VOIP, and answering machines.

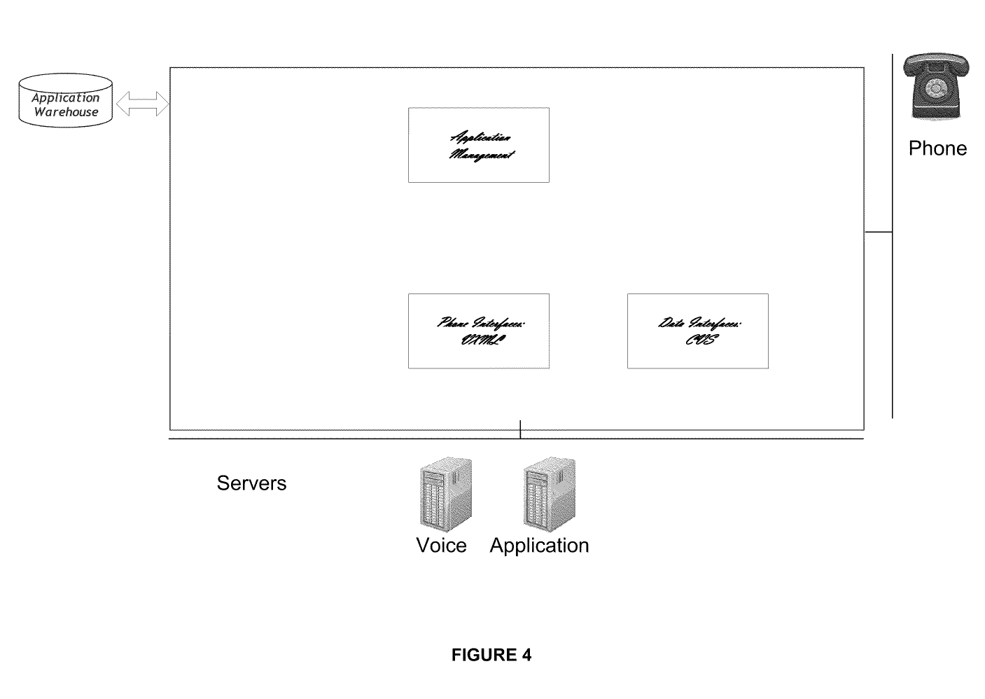

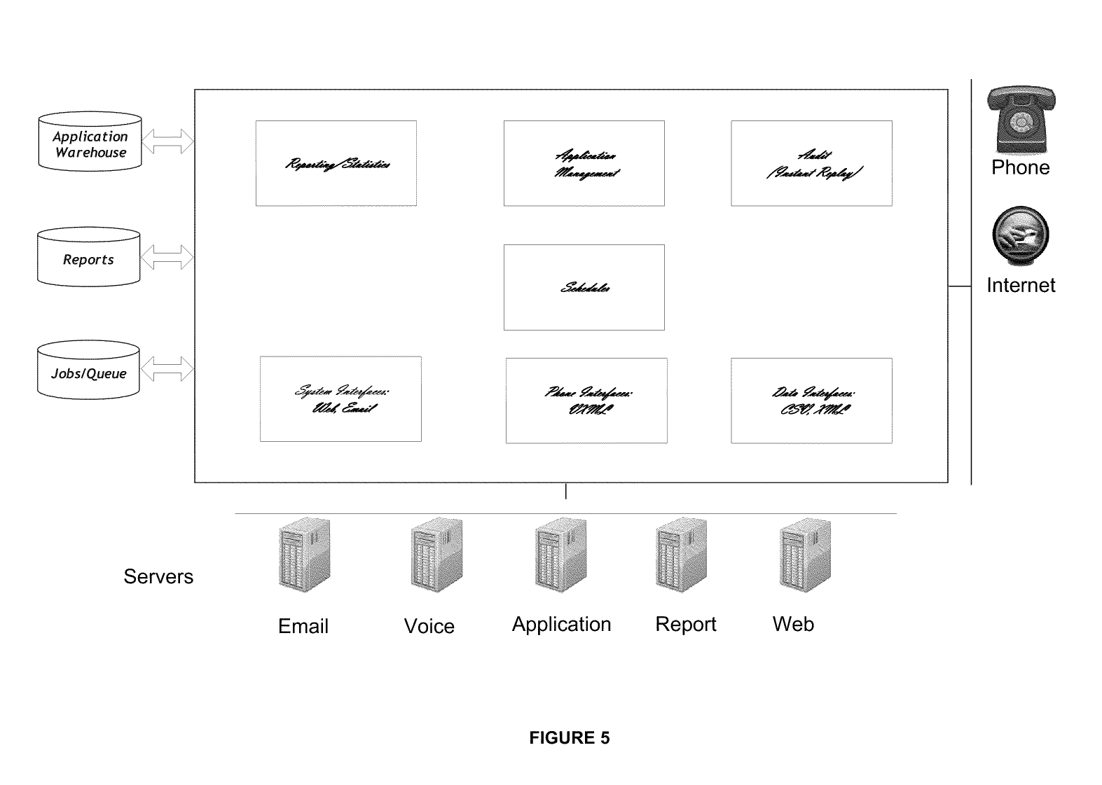

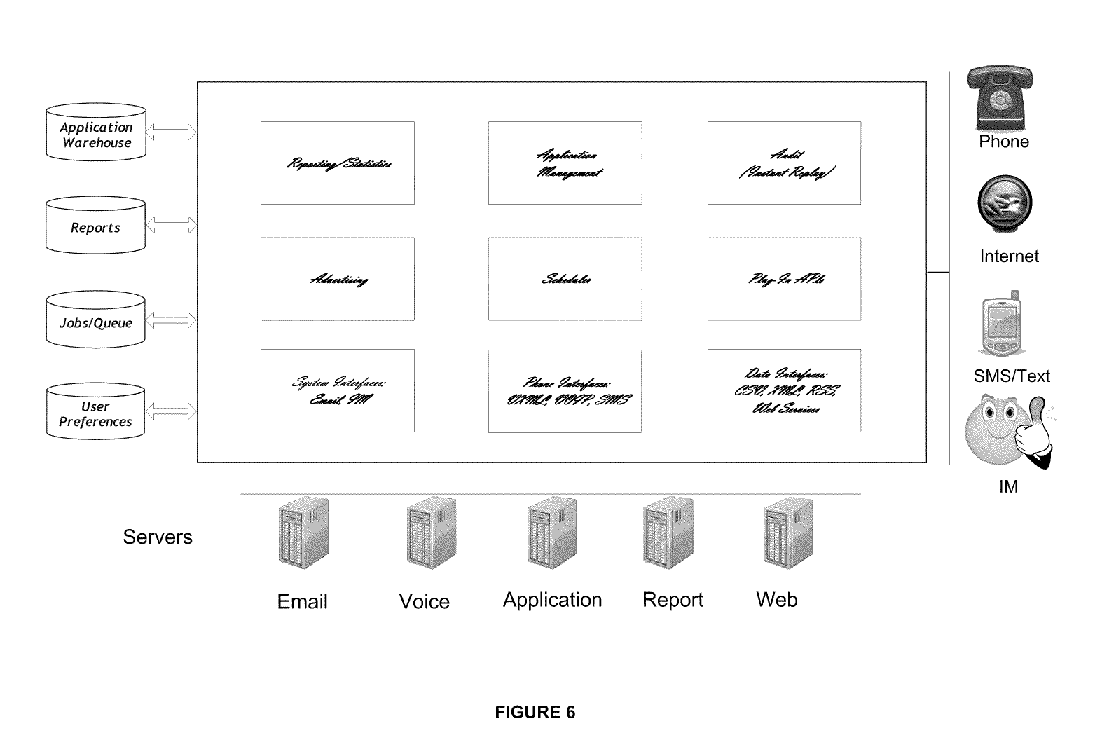

The platform can be customized for different categories of users. In some embodiments, the system can be configured as shown in FIG. 4 for minimal involvement by the user. In these embodiments, the platform has been configured to be operated as a managed service for the user so minimal components (and associated functions) of the platform are present. In other embodiments, the system can be configured as shown in FIG. 5 for more involvement by the user relative to the configuration FIG. 4. In the embodiments shown in FIG. 5, the platform has been configured to be operated as a semi-managed service for the user so that a moderate amount of the components (and associated functions) of the platform 10 are present. In yet other embodiments, the system can be configured as shown in FIG. 6 for maximum involvement by the user. In these embodiments, the platform has been configured to be operated as a self service for the user so the maximum number of components (and associated functions) of the platform are present.

In some embodiments, the platform 10 can be used to automate the communication and interaction between a user (or users), the user's messaging system, and the platform. In these embodiments, the user's device 15 comprises any messaging system known in the art, including a voice mail system. In some embodiments, the voice mail system can be an integrated component of the user's device 15, such as when the user's device comprises a home telephone and the voice mail system contains an answering machine. In other embodiments, the voice mail system can be separate from the user's device, such as when the user's device is a cellular telephone, the voice mail system resides on a computer system operated by the telephone provider and accessed by the user with the cellular telephone. In yet other embodiments, the user's device comprises a voice mail system operated by a computer that is part of an internal network of the user (i.e., a LAN operated by a doctor's office). These systems can also include voice or other messages left on communication providers and/or communication portals like Skype, Yahoo, Twitter, Facebook, and the like.

With any message system, it does not matter how the message is left on what medium is used to leave the message, only that the message is left. The entity with whom the message is left can then respond back using any medium, and the system can receive that response as well as take action. For example, if a voice mail or instant message is left with a user (a patient) letting them know about a doctor's appointment, overdue item, upcoming event/end of auction/sale, change in practice time, or payment due, a response to that message is typically sought. The system can automatically leave the message (whether voice, text, or other medium), automatically receive the return reply (whether voice, text, or other medium), if necessary replay the question and/or notification that was given to the patient, take the response, run automation and update accordingly (i.e. via system/database update or a report), and record all of the interactions, as needed. One example of the automation/update procedure includes updating a 3^{rd} party appointment records software system with a confirmed status if the patient indicated that they will be at the appointment in question or a “cancelled” status if the patient indicated they will not attend. Another example of the automation/update procedure includes restarting a server, fail over to a backup/alternate server, and/or run server diagnostics and report results back to the proper person in order for that person to make the proper decision. For instance, a server administrator receives a message that a server is low on memory. The administrator can call into the system, authenticate themselves, and then have either diagnostics run with the results being given to the administrator in real time, and/or the administrator can give a command to take the server off-line. Yet another example of the automation/update procedure includes being able to automatically process a payment, if the person authorizes the transaction.

Voice mail systems have been used before to help in communication with a user. But communication using voice mail systems have been limited because of the minimal functionality they contain. For example, when a voice message is left on a voicemail system, it is difficult to confirm that the entire message has been less and that the user has received the entire message. Another example is that is has been difficult to confirm the identity of the user receiving the voice mail to verify that the message reached the correct person. As well, it is often inconvenient for the user upon listening to the voicemail to reply to the originator of the communication. But using the platform can described above allows the user to receive the entire message from a voice mail, confirm that the entire message has been received, confirms the receiving user, and allows the user to reply to the voicemail at a time that is convenient for the user.

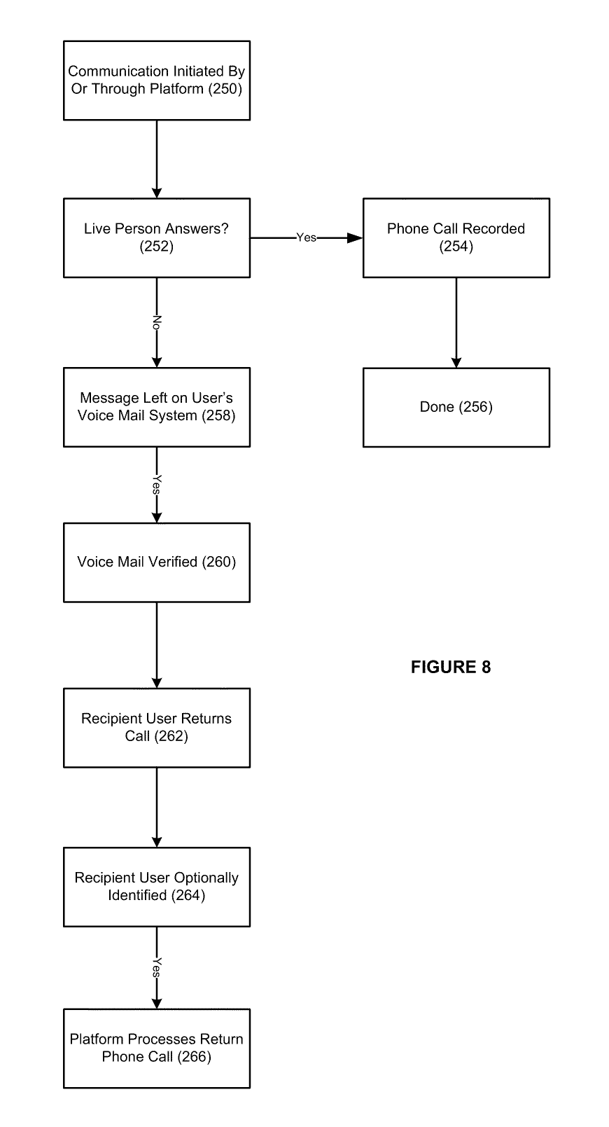

In some embodiments, a communication method 200 can be initiated by or through the platform as shown in box 250 of FIG. 8. Of course, other methods need not include all of the processes illustrate in FIG. 8, may omit some of the processes, and/or may contain additional processes not depicted in FIG. 8. As well, the processes illustrated need not proceed sequentially in the order listed.

The communication can be either a live communication when a specific user (the initiating user) initiates the communication with another user (the receiving user) by utilizing the platform 10. As well, the communication can be a scheduled communication when the platform has been scheduled to begin a communication by calling the receiving user. In these embodiments, the communication can comprise a phone call to the phone number of the recipient user.

The communication method 200 continues, as shown in box 252, when the phone call is received by the recipient user. If the recipient user receives the phone call, then the platform 10 can be used to record the phone conversation between the initiating user and the receiver user or, alternatively, between the IVR used by the platform and the receiving user, as shown in box 254. At that point, the communication method 200 finishes, as shown in box 256.

On the other hand, if a live person does not answer the recipient user's device 15, then a message about the topic of the communication can be left on the recipient user's voice mail system, as shown in box 258. In some embodiments, such as when the user is an individual, the initiating user or the platform 10 merely waits until the appropriate time to leave the message (i.e., when the voice mail system indicates it is ready). In other embodiments, though, the platform 10 can be used to navigate through the phone prompts of the user's recipient's voice mail system until the appropriate location is reached when a voice message can be left.

During the process of and/or immediately after leaving the voice message, the platform 10 can be used in some embodiments to verify that the entire communication desired for the voice message has been left for the recipient user. This function can be performed by the platform 10 by one or more of the following actions: reviewing the transactions/recordings after the completion of the communication and/or using an entity's response as a confirmation or receipt (i.e., email receipt notification or “press 1” to indicate that you understand). For voice mail systems (i.e., answering machines) that work with pauses, interruptions and/or disconnects to replay messages and/or determine when the messaging system hung up, a partial message can be left in 2 ways. Either the user can start leaving a message before the answering machine is ready or the user continues leaving a message when the answering machine stops listening. By using with of these two actions actions the platform 10 can have a high success rate that the entire message is left and that transparent visibility, reporting, and auditing functions exist. And the platform 10 is able to report that the desired content of the message has been left to the initiating user.

As well, the platform 10 can be used to verify that the voice mail has been left for the specific recipient user, as shown in box 260. When a live person answers the phone, there is often no need for any verification of the identity. But when a voice message is left, it would be beneficial to verify that the message is left for the recipient user rather than another person. To achieve this functionality, the platform 10 couples the message with any desired inbound functionality. For example, the platform 10 can leave a message to have a specific person call back. Upon receiving the inbound call, the platform 10 can let that person know that this is a private message for a particular individual and by “pressing 1”, they are legally indicating they are that person. In another example, the platform 10 can combine the CallerID function with commonly used identifying questions like passcode, last 4 digits of social, and the like. So, knowing that a certain user is calling from his home residence and provides either a passcode or last 4 digits of the social can help identify that user (or even users that can act on their behalf). And the platform 10 is able to confirm to the initiating user that the message has been left for the desired recipient user on that user's voice mail system.

The communication method continues when the recipient user retrieves the voice message. In some embodiments, the voice message/mail can be retrieved by using IVR technology to convert the voice mail to text that can be read by the recipient used in an email or a text message on a cell phone. In other embodiments, though, the voice mail can be retrieved when the recipient user just listens to the voice mail.

On listening to the voice message/mail, the recipient user is able to immediately contact the initiating user regarding the subject matter of the voice mail. Such a functionality conventionally exists when the initiating user (or this user's agent) is typically available for the return call (i.e., during business hours). But this functionality has not been available when the user or the agent is not available. In such instances, the return user has had to wait until the initiating user (or agent) has a live person available to handle the return phone call.

But using the platform 10 allows, but does not require, the recipient user to call back at any time, including immediately after receiving the voice mail. This functionality can be very useful since one desirable time for a recipient user to return the call or to otherwise respond to the voice mail is right after receiving the message, when the subject matter is fresh in the memory of the recipient user.

In some embodiments, the return call by the recipient user can be coupled to the message left on the voice mail system. In these embodiments, the recipient user can use the message on the voice mail to automatically reply to the initiating user. In some configurations, this functionality can be performed by using the CallerID action to call back. In some embodiments, the system can leave a message and have the CallerID be any CallerID that the customer would like.

When the return call is placed by the recipient user, the identity of that specific user can optionally be confirmed during the phone call, as shown in box 264. In some configurations, the identity of the user can be confirmed by the caller identifying themselves via the inbound application flow (like “pressing 1 to indicate you are so and so” and/or inputting identifying information like last 4 digits of the social security number) and/or by using the phone number from the recipient user calls. In other confirmations, the identity of the user can be confirmed by the any procedures known in the art, including those described in U.S. Pat. No. 7,440,900.

During the return phone call, the platform 10 can be used to handle or process any desired request or need of the recipient user, as shown in box 266. For example, if the purpose of the return call was to confirm an appointment for a given time, the platform 10 can record that confirmation. As another example, if the purpose of the return phone call was to re-schedule an appointment for a time other than the scheduled time, the recipient user can navigate through the phone prompts on the platform 10 to help the recipient user re-schedule the appointment.

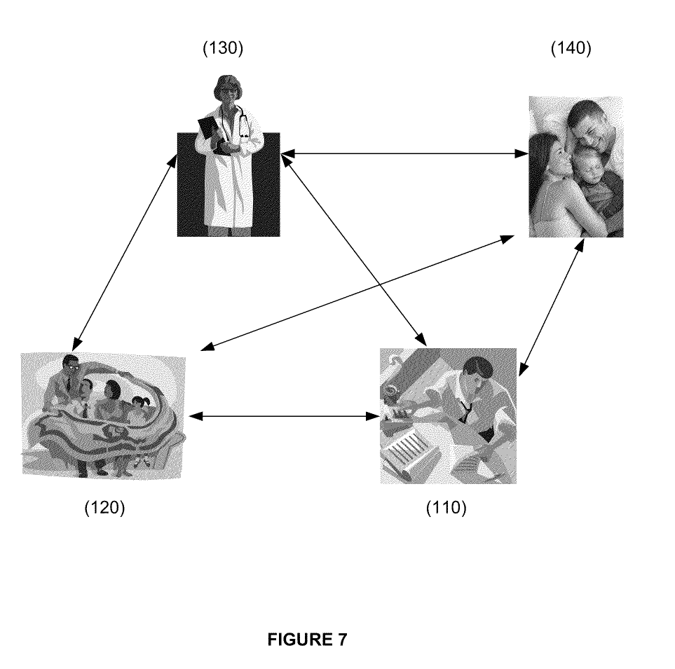

An example of this communication method can be illustrated using FIG. 7. In this Figure, a first user (doctor's office 130) needs to communicate about a scheduled appointment with a second user (patient 140). The platform 10 can be used by the doctor's office 130 to make a phone call to the patient 140 about the upcoming appointment that the patient is scheduled for in the doctor's office. The call from the doctor's office can be initiated by either a live person in the doctor's office or by the platform 10. The platform 10 could initiate the call because of a live request by a person at the doctor's office, such as by using an email request. On the other hand, the platform 10 could be configured to initiate the phone call at the occurrence of a scheduled event, such as a certain time period (i.e., 24 hours) before the scheduled appointment.

If the patient answers the phone call, the message about the upcoming appointment can be given directly to the patient. The time of the phone call, the identity of the user (using the answered phone number), and the entire conversation with the patient can all be recorded by the platform 10. If the patient does not answer the phone, the platform can leave a message about the schedule appointment on the voice mail system of the patient. In certain instances, the platform might need to navigate the phone prompts of the voice mail system to leave a message. The platform 10 verifies that the entire message has been left on the patient's voice mail using any of the actions noted herein.

When the patient returns the call, the platform 10 can identify the patient. In some embodiments, the platform can identify the patient using any of the actions noted herein. In other embodiments, the platform can identify the patient using the phone number from which the patient calls, such as a home phone number which the doctor's office has associated with this particular patient.

When the patient returns the call, the platform 10 can route the call to the doctor's office using any desired parameters. For example, of the return call comes in during the operating hours of the doctor's office, the platform 10 can be configured to forward the call to a specific person at the doctor's office. As another example, the platform can be configured for the patient to enter a first number to confirm the appointment or a second number to re-schedule the appointment by being transferred to the doctor's office. In some embodiments, the patient can re-schedule the appointment using the platform 10 which, by interfacing with the doctor office's internal computer network, can inform the patient of the available appointments and allow the patient to select one of those appointments. If needed, the doctor's office could grant access to the platform 10 so that it can change the appointment in that internal computer network. The platform could then be used in a similar manner to communicate with the medical billing office 120 and the insurance company 110. If needed, the platform 10 can be configured using any communication parameter so that when that parameter is met, the platform 10 can place an outbound telephone call on behalf of any user (a doctor's office) to any other user (the medical billing office 120 or the insurance company 110). If needed, the platform could navigate that user's system or voice mail system (using IVR) to leave a message.

The platform 10 can increase the efficiency of communications between two or more users that use voice mail systems. In many industries, especially the health care industry, there are multiple users that need to repeatedly and effectively communicate with each other. Examples of the users in the health care industry include insurance companies, medical offices, billing companies, collection agencies, and patients, as well as the customers and partners of these users. But when these entities communicate with each other, there are numerous inefficiencies because of incomplete voice messages, the initiating user not always have a live person available, etc. The systems and methods described herein can overcome these inefficiencies by using the platform 10 to organize and manage the communication flow between the multiple users and their voice mail systems. The platform 10 can therefore be used to partially or wholly automate the communication flow between the two (or more users/voice mail systems).

In some embodiments, the platform 10 can provide substantial real-time interactivity with any number of users. To obtain this real-time interactivity, all voice mail responses, DTMF, instant message, SMS, email, etc. may be configured within the application on the application server to obtain information from the user (whether recipient or initiator). For example, the platform 10 could be configured to collect any user input such as authentication, authorization, or confirmation when multiple users are interacting in substantial real-time over the phone.

In some embodiments, the platform 10 can be customized for each user. In these embodiments, the platform 10 can be customized to create an application template that is specific to the needs of that user (or group of users) or the voice mail system. The template(s) can be created using the configuration engine 85. The applications may be created in one or more of the following methods. First, by entering text, such as through a web interface, and then the entered text can be played over the phone using the speech engine. Second, the applications can be by submitting content via email, ftp, or other API method. For example, the submitted content may comprise pre-recorded content (audio files, advertisements) or existing text content (such as from email services, news services, RSS feeds, etc.) about any desired topic. Third, an application can be created by recording prompts and/or questions through a web interface or over the phone. Recording desired content over the phone can involve either an inbound or an outbound process. In an inbound process, an individual user can call into a specified phone number, subsequently record desired content over the phone, and optionally follow a series of prompts which guides the caller through the various parts of the template. In an outbound process, an individual user can enter a phone number, such as through a web interface. This action can then trigger a call back to the user who can then record the desired content over the phone, optionally followed by a series of prompts which guide the caller through the various parts of the template. Fourth, an application can be created by uploading prerecorded content that includes, for example, audio files, video files, etc.

Using the platform 10, a variety of data can be collected. The data can be analyzed and reported/used for a variety of purposes such as analytics. First, as noted above, the data can be used for the platform 10 to determine whether the correct user has been reached. The data about the voice mails and the messages left on the voice mail systems can also be used to determine most desired/effective communication mechanism(s).

Second, the data can be used to improve user relationships, as known in the art, and thereby maintain and create lasting relationships with users. The ability to monitor user transactions and user voice mail systems allows determination of common trouble spots in the user interaction with the system, including interactions with the platform or components thereof. With this information, the system can remove or change the trouble spots and make the system and platform more user friendly. Also, by receiving and being able to monitor large amounts of detailed feedback from the voice mail systems and the messages, the system may be better equipped to make decisions that reflect the wants and needs of the various users of the platform 10.

Third, the collected data can be used to enhance and/or customize the operation of the system and/or the platform. For example, a system administrator could monitor fault and performance data to identify factors that slow transactions or communication. In some aspects, the collected data can be used to enhance the service levels of systems (like up-time) and services. In other aspects, the collected data could be used to assess areas of improvement for user's own processes such as in the voice mail systems and the replies to the voice messages. For instance, for claims collection, the platform will be able to determine things like which types of return calls come in and which agents handle the return calls and in what time frames (and assessing possible areas of training).

Fourth, the collected data may be shared with third parties (including non-users and supervising/government agencies) that are not part of the transaction leading to the voice message/mail. The collected data may be shared using a variety of techniques, including actively communicating to third parties using, for example, e-mail, EDI, DEX/UCS, or by uploading the data to a separate computer controlled by the third party. The collected data can be reported to or monitored by the third parties by either transmitting it to the third parties or by allowing the third parties to access the platform 10, either directly or indirectly through the web portal. In the former situation, the collected data may be optionally collated, analyzed, summarized, or otherwise processed using a variety of steps. This situation allows the operator of the system to perform the analysis, filter the results, and/or customize the report that is sent to the third party. In the latter situation, the third party can monitor the collected data before (or as) it is received from the user devices or anytime during the analysis, filtering, or customization process. Of course, access to the platform by the third party can be established using any parameters desired by the operator of the system, i.e., access to only certain portions of the collected data.

Alternatively, the collected data need not be transmitted to the platform before being monitored by or reported to third parties. In these aspects of the systems, the data can be monitored by transmitting it to the third parties from the user device(s). This situation gives the third party more access to the raw data that has been collected, but does not necessarily allow the operator of the system to analyze, filter, or customize the report. Of course, access by the third party can be established using any parameters desired by the operator of the system, i.e., access to only certain portions of the collected data.

Fifth, the collected data can be used for auditing and/or legal purposes. In these embodiments, the identity of the user, the time the voice mail was left, the voice mail itself, and any conversation with the user of any type of messaging can be recorded and kept by the platform. This information can be used to verify that the user (patient) presumably received the voice message. This verification can be important to some users, like doctors' offices, for any number of reasons depending on the reason and the purpose of the message.

The platform 10 can also issue any type or number of reports to the user(s), the operator of the platform 10, and even third parties. One report that can be issued comprises a resolution report. The resolution report can be used by the users to determine the parameters of the resolutions of all of the transactions over which they have been communicating about. For example, the resolution reports could include information about which users had transactions that were more statically resolved than other users, the percentage of transactions that were actually resolved, which types of transactions were statistically resolved (and which were not), the time (both in calendar time and allocated resources) needed to resolved a transaction, the number (or average) of interactions with a particular user (or category of user) that were needed to resolve a transaction, the specific agents of a user that were more successful at resolving transactions, which transactions were easier to resolve than others, which transactions could be partially resolved, which vendors take longer or shorter to resolve certain transactions, etc. As an example, if a biller takes 5 times longer to resolve a type of claim than all other billers, this information could be reported. Further, insurance companies could set limits on which billers are allowed to contact them via what mechanisms.

Another report that can be issued by the platform 10 is an audit report. The platform 10 can record details about every communication and then store/archive those details. In some embodiments, the platform 10 can record activities like which voice messages were attempted, when they were attempted, the users and voice mail systems involved, the details of the communication, and the end result of the communication. For example, each transaction (i.e. call placed or return call) can be implemented as either a static or dynamic application. Depending on the desires of the user, if the static application is chosen, the source code for each communication can be saved and stored for future reference. In some instances, when a transaction starts and a telephone call is placed to a specific user, a unique application will be generated. That application (html, vxml, or other) can be used for the actual communication with that particular user. The communication itself (i.e. 2 agents talking) can be recorded, if desired, and the application source code, end status, and any other possible data points can be archived for any desired purposed, including any customer or government audit.

Other reports include interaction durations, agent efficiency and company/entity efficiency in handling various claims calls, as well as customer satisfaction surveys. These and other reports can cross-reference data to provide even new reports. Examples of these new reports are overall volume, number of attempts, effort level, and end result of a particular type of claim across the industry. For instance, one insurance provider may process 20% of all of the transaction volume for a particular type of claim. While processing these claims, the average provider attempts could be 4 with an average duration of 3 minutes while achieving a 70% successful resolution rate. Conversely, another insurance company may process 10% of the total volume of the same type of claim. In this case, they may be successfully resolving 80% of the claims with only 1 attempt per provider at an average 2 minutes.

The systems described above can be used to perform a variety of methods. One of the methods, as described above, involves the communication method 200 illustrated in FIG. 8. The system can also be used to collect data from the user's device or voice mail system, whether individually or collectively. Any data or information can be collected when it is transferred from the user's device 15 to the platform 10. The collected data can include financial data. Examples of the types of financial data include payment information, sales information, credit/debit/gift card information, accounting information, other electronic payment information (for instance PayPal) and so forth. As a user's device can be a system, any type of data can be collected (as long as the appropriate mechanisms and authentication are provided). For instance, for claims collection, the platform 10 can gather information about the status of a claim from an insurance company's system. Examples of other types of data include user information about the voice, the emotion of the voice, syntax, and volume level, as well as checking account information and demographic data. The data can be transferred on a periodic basis, on a semi-dynamic basis, or on a real-time basis. This information about the user devices, whether individual or collective, can be communicated to users desiring to enter into a transaction because this will allow the users to optimize the communication mode they respectively use.

Other methods allow the operator of the platform to configure and customize information presented to a user. In some embodiments, the platform can be used to analyze or manipulate the information for any number of purposes, especially in the context of the information presented to multiple users during a transaction. For instance, the platform 10 could be used to collected the data from a first user in a first format (consistent with the first user's communication mode) and then manipulate/change that information into a second format for the second users (consistent with the second user's communication mode).

In some embodiments, certain notification actions, including actions that are taken on a proactive basis, can be sent to the user(s). The need for this type of communication revolves around the need to proactively notify account owners of events that may require action, such as authorizing pending transactions, transferring funds from one account to another, making a payment, soccer practice being changed to a different time, etc. The following account events could trigger notification: account balance thresholds; transaction verification of pending or completed transactions, especially those that may exceed a given amount; password change/reset; credit card transaction; account upgrade changes; complaints; payment failure; negative balance/overdraft; other events related to financial account activity; fund transfers; balances coming due; etc. The action can be used to notify users of information, such as account information other events, including—but not limited to—pending or completed transactions, balances, and available funds, appointment reminders, medication reminders, severe weather notices, school closures, a change in game/practice schedule, etc. Notification may be conducted via any communication channel, whether that channel is part of the selected communication mode for a user. In some embodiments, the notification can include a notice that a transaction is desired between multiple users.

The notification action can be based on the profile of the user. In these embodiments, the account owner can determine the desired communication mode by specifying the preferred method(s) of contact, across phone, email, IM, other social networking mechanisms (such as Twitter), text or other mechanism, preferred time of contact by time of day or day of week, the type of data or information that could be received by any specific user device, or any another communication mode component. In other embodiments, the notification can be based on the profile of a transaction.

The methods and systems described above have several features that are very useful. The users can save time and increase accuracy, scalability, and visibility while reducing cost and frustration during their communications. The users can also be provided with reports detailing possible areas of improvement for further operational gains and/or cost savings. The system can also provide a helpful link between users that are companies. By interacting with the voice mail systems, the platforms is able to verify the user, verify that the entire voice Another useful feature includes integrating with the doctor's office software to place appointment confirmation calls, emails, etc.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A communication method, comprising:
providing a communications platform capable of handling multiple types of communications with multiple users, comprising:
a browser for a communications network;
a server for handling communications between the platform and user devices that are external to the platform; and
a speech engine for converting text to speech, for converting speech to text, or both;
connecting a communications network to the communications platform;
providing an interface between the communication platform and the communications network;
connecting a user device to the communications network, the user device containing a message system; and
using the platform to leave a message for the user on the message system of the user's device.

2. The method of claim 1, further comprising verifying that the entire message has been left on the message system.

3. The method of claim 3, wherein the verification process comprises reviewing a recording of the message after it has been left on the message system.

4. The method of claim 1, further comprising verifying the identity of the user.

5. The method of claim 4, wherein the identity of the user if verified by coupling the message with an inbound functionality of the platform.

6. The method of claim 1, wherein the type of user device comprises a desktop computer, a laptop computer, a server, a telephone, a mobile or cellular phone, a personal digital assistant (such as a Palm Pilot, iPaq, Blackberry device), an automated calling system, any known interactive voice response device, an answering machine, a portable electronic device, a mobile hand held device, any electronic device containing computing software or an application programming interface, or any combinations thereof.

7. The method of claim 1, further comprising using the platform to receive a return message from the user.

8. The method of claim 1, wherein the message system is integrated with the user's device.

9. The method of claim 1, wherein the message system is not integrated with the user's device.

10. The method of claim 1, wherein the message system comprises a voice mail system.

11. A communication method, comprising:
providing a communications platform capable of handling multiple types of communications with multiple users, comprising:
a browser for a communications network;
a server for handling communications between the platform and user devices that are external to the platform; and
a speech engine for converting text to speech, for converting speech to text, or both;
connecting a communications network to the communications platform;
providing an interface between the communication platform and the communications network;
connecting a user device to the communications network, the user device containing a message system;
using the platform to leave a message for the user on the message system of the user's device; and
verifying that the entire message has been left on the message system.

12. The method of claim 11, wherein the verification process comprises reviewing a recording of the message after it has been left on the message system.

13. The method of claim 11, further comprising verifying the identity of the user.

14. The method of claim 13, wherein the identity of the user if verified by coupling the message with an inbound functionality of the platform.

15. The method of claim 11, wherein the type of user device comprises a desktop computer, a laptop computer, a server, a telephone, a mobile or cellular phone, a personal digital assistant (such as a Palm Pilot, iPaq, Blackberry device), an automated calling system, any known interactive voice response device, an answering machine, a portable electronic device, a mobile hand held device, any electronic device containing computing software or an application programming interface, or any combinations thereof.

16. The method of claim 11, further comprising using the platform to receive a return message from the user.

17. The method of claim 11, wherein the message system is integrated with the user's device.

18. The method of claim 11, wherein the message system is not integrated with the user's device.

19. The method of claim 11, wherein the message system comprises a voice mail system.

20. A communication method, comprising:
providing a communications platform capable of handling multiple types of communications with multiple users, comprising:
a browser for a communications network;
a server for handling communications between the platform and user devices that are external to the platform; and
a speech engine for converting text to speech, for converting speech to text, or both;
connecting a communications network to the communications platform;
providing an interface between the communication platform and the communications network;
connecting a user device to the communications network, the user device containing a message system;
using the platform to automatically leave a message for the user on the message system of the user's device;
automatically receive a return message from the user while verifying the identify of the user; and
recording all communications between the user and the platform.
